(19) United States
(12) Patent Application Publication
(10) Pub. No.: US 2013/0226506 A1
(43) Pub. Date: Aug. 29, 2013

(54) Physical Quantity Detection Device, And Network System

(71) Applicants: Toshiaki Nakamura, Hitachinaka (JP); Masahide Hayashi, Mito (JP)

(72) Inventors: Toshiaki Nakamura, Hitachinaka (JP); Masahide Hayashi, Mito (JP)

(73) Assignee: Hitachi Automotive Systems, Ltd., Hitachinaka-shi (JP)

(21) Appl. No.: 13/879,566

(22) PCT Filed: Oct. 20, 2011
(86) PCT No.: PCT/JP2011/074106

§ 371 Date: May 21, 2013

(30) Foreign Application Priority Data
Oct. 28, 2010 (JP) 2010-242351

(51) Int. Cl. G06F 17/00

(52) U.S. Cl. CPC G06F 17/00
USPC 702/141; 702/189; 702/145

(57) ABSTRACT

An object is to provide a physical quantity detection device capable of reducing a communication load for transmitting a sensor detection result, and also, of reducing a processing load of a receiving device receiving the sensor detection result.

In a case a sensor is not normally operating, the physical quantity detection device according to the present invention transmits a diagnosis result without transmitting a detection result of the sensor (see FIG. 4).

### TECHNICAL FIELD

The present invention relates to a device for detecting a physical quantity.

### BACKGROUND ART

To secure safety at the time of travelling of a vehicle, sensors for detecting angular velocity and acceleration are necessary. For these sensors to be installed, and to operate, in an environment where the range of temperature change is large and the influence of vibration or electromagnetic noise is great, such as an engine room, an improvement for maintaining high reliability of sensor output is necessary.

Accordingly, a sensor used in such an environment includes a self-diagnosis function inside the sensor, and transmits diagnosis information to an external device together with a sensor output. The external device determines, based on the received diagnosis information, whether the received sensor output is normal or not, and decides whether to use the sensor output or not.

Patent Literatures 1 and 2 mentioned below describe a sensor for detecting a physical quantity such as angular velocity or acceleration, and transmitting the detection result and a diagnosis result regarding the operating state of the sensor to an external device.

According to the technique described in Patent Literature 1, a malfunction diagnosis output at the same time as a sensor output is output in a time divisional manner by an output circuit. An external device determines, based on the malfunction diagnosis output, whether a sensor output to be output at the next time is normal or not.

According to the technique described in Patent Literature 2, in the case a sensor unit is determined to be malfunctioning, a sensor output is lowered to a ground level (0V) to thereby notify an external device that the sensor output is abnormal.

### CITATION LIST

### Patent Literature

PTL 1: JP 4311496 B1

PTL 2: JP 2000-2542 A

### SUMMARY OF INVENTION

### Technical Problem

According to Patent Literature 1, a diagnosis result regarding the operating state of the sensor has to be transmitted together with the sensor output, and thus, the communication load is large. Moreover, the processing load of an external device receiving the sensor output is also increased.

According to Patent Literature 2, since the abnormality state is notified to an external device by the sensor output itself, even if the sensor output is abnormal, an equal amount of information as a normal sensor output is necessary. Thus, as with Patent Literature 1, there are issues that the communication load and the processing load are increased.

The present invention is made in order to solve the issues described above, and aims to provide a physical quantity detection device capable of reducing a communication load for transmitting a sensor detection result, and also, of reducing a processing load of a receiving device receiving the sensor output result.

### Solution to Problem

A physical quantity detection device according to the present invention transmits a diagnosis result without transmitting a detection result of a sensor in the case the sensor is not normally operating.

### Advantageous Effects of Invention

According to the physical quantity detection device of the present invention, the communication load may be reduced by not transmitting a detection result of a sensor that is not normally operating. Further, the processing load of the receiving side of the detection result of the sensor may be reduced.

### BRIEF DESCRIPTION OF DRAWINGS

FIG. 1 is a control circuit diagram of a physical quantity detection device 1000 according to a first embodiment.

FIG. 2 is a functional block diagram of a communication unit 171.

FIG. 3 is a diagram showing a format of data held in a data buffer 1711.

FIG. 4 is a diagram showing an operational flow of a selection unit 1712.

FIG. 5 is a diagram showing an example configuration of a communication frame that is to be output by a communication frame forming unit 1714 as a result of the operational flow in FIG. 4.

FIG. 6 is a configuration diagram of a network system 10000 according to a third embodiment.

FIG. 7 is a functional block diagram of an ECU 2000 for ESC.

FIG. 8 is an operational flow at the time of the ECU 2000 for ESC receiving a communication frame from the physical quantity detection device 1000.

FIG. 9 is a diagram showing a structure of a definition table 300 held in a ROM 202 of the physical quantity detection device 1000 and example data.

FIG. 10 is a diagram showing a structure of a definition table 2100 held in each ECU and example data.

### DESCRIPTION OF EMBODIMENTS

### First Embodiment

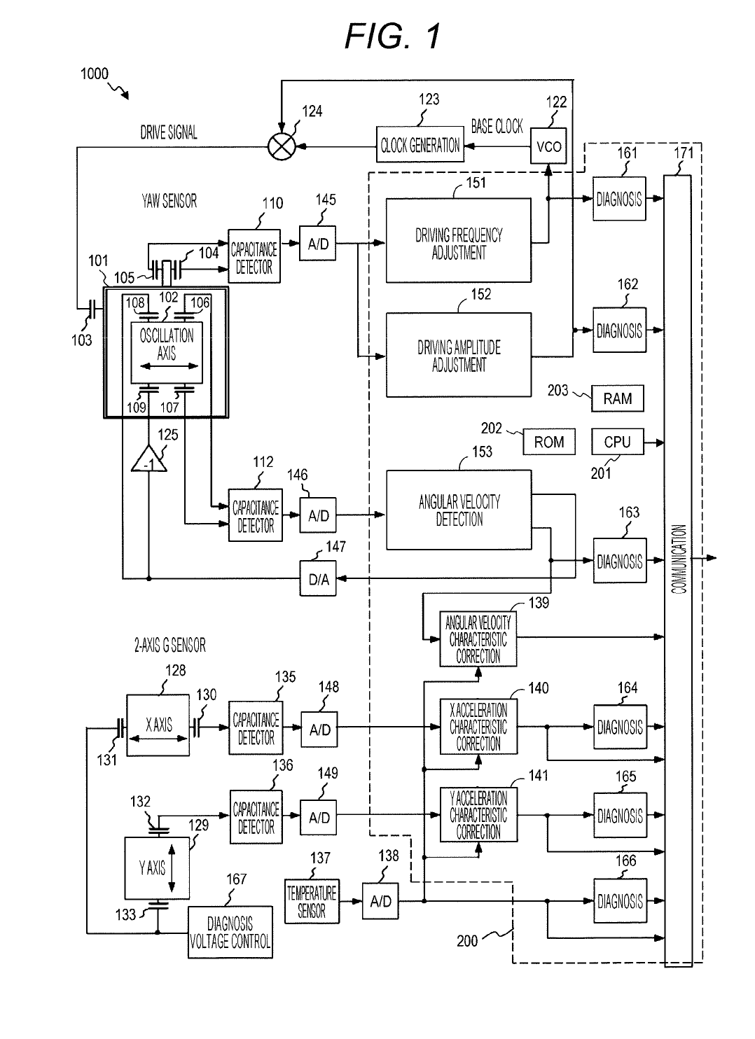

FIG. 1 is a control circuit diagram of a physical quantity detection device 1000 according to a first embodiment of the present invention. In FIG. 1, an angular velocity sensor 101 is a sensor for detecting angular velocity, and includes an oscillator 102, a fixed electrode 103, electrodes 104 and 105, fixed electrodes 106 and 107, and fixed electrodes 108 and 109.

The oscillator 102 has a predetermined mass, and oscillates at a predetermined oscillation frequency in an oscillation axis direction. The fixed electrode 103 exerts an electrostatic force to adjust the oscillation frequency and the oscillation amplitude in the oscillation direction of the oscillator 102. The electrodes 104 and 105 detect the oscillation amplitude and the oscillation frequency of the oscillator 102 based on a change in electrostatic capacitance. The fixed electrodes 106 and 107 detect displacement of the oscillator 102 in the direction orthogonal to the oscillation axis caused by a Coriolis force occurring at the time of application of the angular velocity, based on a change in electrostatic capacitance. The fixed electrodes 108 and 109 exert an electrostatic force on the oscillator 102 so as to cancel the Coriolis force acting on the oscillator 102.

A capacitance detector 110 detects displacement in the oscillation direction acting on the angular velocity sensor 101, by detecting a difference between the electrostatic capacitance between the angular velocity sensor 101 and the fixed electrode 104 and the electrostatic capacitance between the angular velocity sensor 101 and the fixed electrode 105.

A driving frequency adjustment unit 151 includes an AD converter 145 that converts an output of the capacitance detector 110 into a digital signal, and an integrator that adds the outputs of the AD converter 145 every specific cycle.

A driving amplitude adjustment unit 152 includes an integrator that takes a difference between a reference amplitude value set in advance and an output of the AD converter 145 and adds the outputs every specific cycle.

A capacitance detector 112 detects displacement due to the Coriolis force acting on the oscillator 102 and converts the displacement into a digital signal by detecting a difference between the electrostatic capacitance between the oscillator 102 and the fixed electrode 106 and the electrostatic capacitance between the oscillator 102 and the fixed electrode 107.

An angular velocity detection unit 153 includes an AD converter 146 that converts an output of the capacitance detector 112 into a digital signal, and an integrator that adds the outputs of the AD converter 146 every specific cycle.

A voltage control oscillator (VCO) 122 outputs a base clock of a frequency according to the output of the driving frequency adjustment unit 151. A clock generation unit 123 frequency-divides the output of the VCO 122, and outputs a drive signal and a detection signal Φ1.

A 2-axis accelerometer includes oscillators 128 and 129, and electrodes 130 to 133.

The oscillator 128 is displaced when acceleration is applied in a left and right direction (hereinafter, referred to as an X-axis direction). The oscillator 129 is displaced when acceleration is applied in a back and forth direction (hereinafter, referred to as a Y-axis direction). The electrodes 130 and 132 each detect the amount of displacement in the X-axis direction or the Y-axis direction by a change in the electrostatic capacitance. The electrodes 131 and 133 each apply voltage and forcefully displace the oscillator 128 in the X-axis direction or the oscillator 129 in the Y-axis direction. Capacitance detectors 135 and 136 each detect a change in the electrostatic capacitance due to displacement, and output the same as voltage. AD converters 148 and 149 each convert the voltage detected by the capacitance detector 135 or 136 into a digital signal. A temperature sensor 137 detects ambient temperature, converts and outputs the same as voltage. An AD converter 138 converts the output voltage of the temperature sensor 137 into a digital signal.

An angular velocity characteristic correction unit 139, an X-axis direction acceleration characteristic correction unit 140 and an Y-axis acceleration characteristic correction unit 141 each correct a detection result of the angular velocity or the detection result of the acceleration according to an output of the temperature sensor 137.

A diagnosis unit 161 determines, based on an output of the driving frequency adjustment unit 151, whether a driving frequency is normal or not. A diagnosis unit 162 determines, based on an output of the driving amplitude adjustment unit 152, whether oscillation of the oscillator 101 in the oscillation axis direction is normal or not. A diagnosis unit 163 determines, based on an output of the angular velocity detection unit 153, whether an angular velocity output is normal or not. A diagnosis unit 164 determines, based on an output of the X-axis direction acceleration characteristic correction unit 140, whether the accelerometer is normally operating or not. A diagnosis unit 165 determines, based on an output of the Y-axis direction acceleration characteristic correction 141, whether the accelerometer is normally operating or not. A diagnosis unit 165 determines, based on an output of the AD converter 138, whether the temperature sensor 137 is normally operating or not.

A diagnosis voltage control unit 167 forcefully displaces the oscillator 128 in the X-axis direction and the oscillator 129 in the Y-axis direction and applies voltage to the electrodes 131 and 133, to thereby diagnose whether the accelerometer is normally operating or not.

The communication unit 171 transmits outputs of the angular velocity sensor 101 and the accelerometer to an external device of the physical quantity detection device 1000.

The part surrounded by a dotted line in FIG. 1 may be integrally configured on an arithmetic device such as a microcomputer 200 or the like. The microcomputer 200 includes a CPU (Central Processing Unit) 201, a ROM (Read Only Memory) 202, and a RAM (Random Access Memory) 203.

The CPU 201 performs an arithmetic function of each function unit provided in the microcomputer 200. The ROM 202 holds programs to be executed by the CPU 201. The RAM 203 temporarily holds data or the like necessary at the time of the CPU 201 executing a program.

Each function unit configured on the microcomputer 200 may be configured as a program to be executed by the CPU 201, or may be configured using hardware such as a circuit device for realizing the function. Further, a function equivalent to the microcomputer 200 or each function unit configured on the microcomputer 200 may be configured using a rewritable logic circuit such as an FPGA (Field Programmable Gate Array).

Heretofore, a circuit configuration of the physical quantity detection device 1000 has been described. Next, an operation of the angular velocity sensor 101 will be described.

The oscillator 102 oscillates by drive signals output by the driving frequency adjustment unit 151 and the driving amplitude adjustment unit 152. The fixed electrodes 104 and 105 detect displacement of the oscillator 102 of the angular velocity sensor 101. The capacitance detector 110 receives the detection result.

The driving frequency adjustment unit 151 adjusts the frequency of the drive signal in such a way that the oscillation of the oscillator 102 in the drive direction is resonant, with respect to a displacement signal of the oscillator 102 obtained via the capacitance detector 110 and the AD converter 145.

The driving amplitude adjustment unit 152 adjusts the amplitude of the drive signal in such a way that the oscillation amplitude of the oscillator 102 in the drive direction matches an amplitude reference value, with respect to a displacement signal of the oscillator 102 obtained via the AD converter 145. Then, a signal that is obtained is output to a multiplier 124. The multiplier 124 multiplies an output of the clock generation 123 and an output of the driving amplitude adjustment unit 152 and generates a drive signal, and outputs the drive signal to the oscillator 102.

The angular velocity detection unit 153 detects displacement of the oscillator 102 due to the Coriolis force by the fixed electrodes 106 and 107 and the capacitance detector 112. The angular velocity detection unit 153 applies voltage to the fixed electrodes 108 and 109, and cancels displacement due to the Coriolis force acting on the oscillator 102 by the electrostatic force occurring between the oscillator 102 and the electrodes 108 and 109. That is, servo control is performed in such a way as to feedback, to the angular velocity sensor 101, voltage that causes the displacement of the oscillator 102 due to the Coriolis force at a right angle to the oscillation axis to be zero. The angular velocity detection unit 153 outputs the amplitude of the fed back voltage at this time as a detection signal of the angular velocity.

More specifically, the angular velocity detection unit 153 applies voltage to the fixed electrode 108 and applies voltage obtained by inverting the voltage by a polarity inverter 125 to the fixed electrode 109 to thereby cancel the oscillation displacement at a right angle to the oscillation axis. The output of the integrator in this state where the oscillation is cancelled is output as an angular velocity detection signal.

Next, an operation of the accelerometer will be described. The oscillator 128 causes, by the acceleration in the X-axis direction, a change in the capacitance according to the displacement to occur at the fixed electrode 130. The capacitance detector 135 outputs, via the AD converter 148, a displacement signal of the oscillator 128 as the acceleration. The same can be said for the oscillator 129 for detecting the acceleration in the Y-axis direction and the capacitance detector 136.

Next, the characteristic correction unit will be described. The angular velocity characteristic correction unit 139, the X-axis direction acceleration characteristic correction unit 140, and the Y-axis acceleration characteristic correction unit 141 perform, for an output of the angular velocity sensor 101 and an output of the accelerometer, according to a detection value of the temperature sensor 137, a temperature correction operation and removal of a high-frequency noise component by a low-pass filter.

Next, the diagnosis unit will be described. The diagnosis units 161 to 163 diagnose whether the driving function and the angular velocity detection function of the angular velocity sensor 101 are normally operating or not. The diagnosis units 164 and 165 cause the diagnosis voltage control unit 167 to apply voltage for diagnosis to the fixed electrodes 131 and 133 of the two oscillators 128 and 129 of the accelerometer and forcefully displace each of the oscillators to thereby diagnose whether a detection element is normally operating or not. The diagnosis unit 166, diagnoses whether an output of the temperature sensor 137 is within an appropriate range or not.

The communication unit 171 outputs sensor outputs corrected by the angular velocity characteristic correction unit 139, the X-axis direction acceleration characteristic correction unit 140 and the Y-axis acceleration characteristic correction unit 141 to an external device. Further, the diagnosis results of the diagnosis units 161 to 166 are transmitted together with the external device.

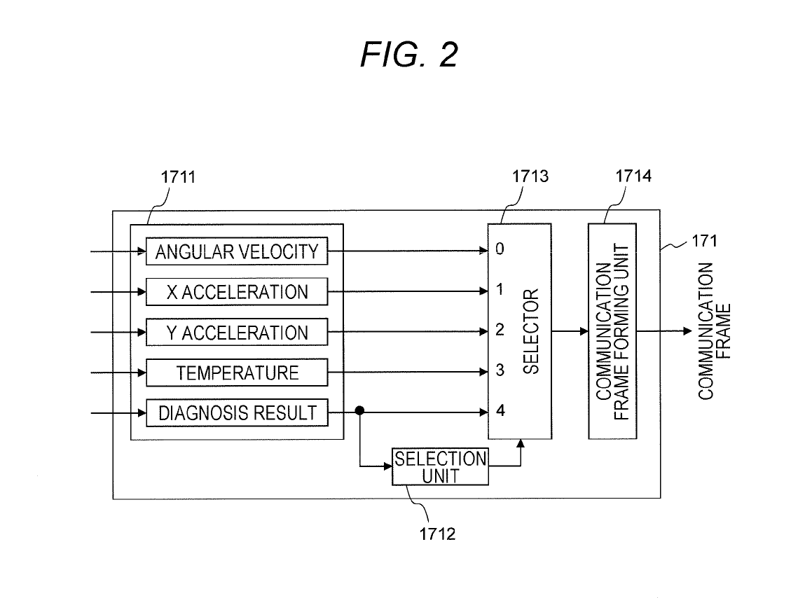

FIG. 2 is a functional block diagram of the communication unit 171. The communication unit 171 includes a data buffer 1711, a selection unit 1712, a selector 1713, and a communication frame forming unit 1714.

The data buffer 1711 receives a detection result of the angular velocity sensor 101 from the angular velocity characteristic correction unit 139, receives detection results of the accelerometer for respective axis directions from the X-axis direction acceleration characteristic correction unit 140 and the Y-axis acceleration characteristic correction unit 141, and receives a temperature detection result from the temperature sensor 137. Further, diagnosis results regarding respective sensors are received from the diagnosis units 163 to 166. Further, diagnosis results regarding a driving frequency and a driving amplitude are received from the diagnosis units 161 and 162.

The selection unit 1712 selects which of the detection results and the diagnosis results held in the data buffer 1711 is to be transmitted to an external device as a transmission packet. The selection unit 1712 outputs the selection result to the selector 1713.

The selector 1713 selects, according to an instruction from the selection unit 1712, a part or all of the detection results and the diagnosis results, and outputs the same to the communication frame forming unit 1714. The communication frame forming unit 1714 shapes a part or all of the detection results and the diagnosis results selected by the selector 1713 into the format of a communication packet, and transmits the same to an external device.

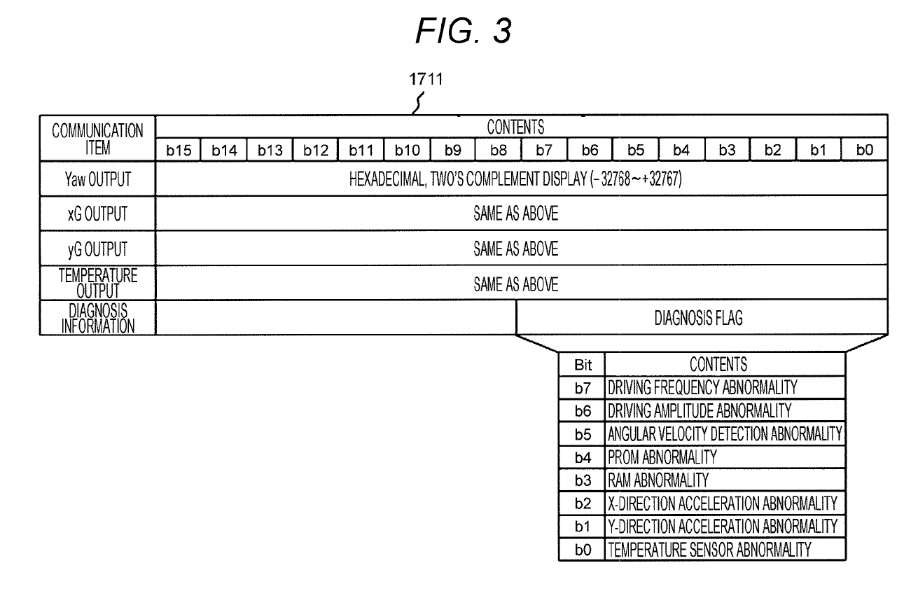

FIG. 3 is a diagram showing a format of data held in the data buffer 1711. In the following, the format of each data shown in FIG. 3 will be described.

The angular velocity sensor 101, the accelerometer, and the temperature sensor 137 each output the detection result as 16-bit data. This detection result expresses a positive or negative signed value as a two's complement, for example. The number of bits may be increased or decreased, or the detection result may be expressed in a different form of expression, according to the required accuracy.

Diagnosis information indicating the diagnosis result of each diagnosis unit is configured as 8-bit data. The bits indicate the diagnosis results regarding the following items using 0 (normal) or 1 (abnormal).
(Bit b7) Driving frequency of the angular velocity sensor 101 (Diagnosis result of the diagnosis unit 161)
(Bit b6) Driving amplitude of the angular velocity sensor 101 (Diagnosis result of the diagnosis unit 162)
(Bit b5) Angular velocity detection function of the angular velocity sensor 101 (Diagnosis result of the diagnosis unit 163)
(Bit b4) Diagnosis result of the ROM 202 (Diagnosed by the CPU 201)
(Bit b3) Diagnosis result of the RAM 203 (Diagnosed by the CPU 201)
(Bit b2) Detection function regarding X (left and right) axis direction acceleration (Diagnosis result of the diagnosis unit 164)
(Bit b1) Detection function regarding Y (back and forth) axis direction acceleration (Diagnosis result of the diagnosis unit 165)
(Bit b0) Temperature detection function of the temperature sensor 137 (Diagnosis result of the diagnosis unit 166)

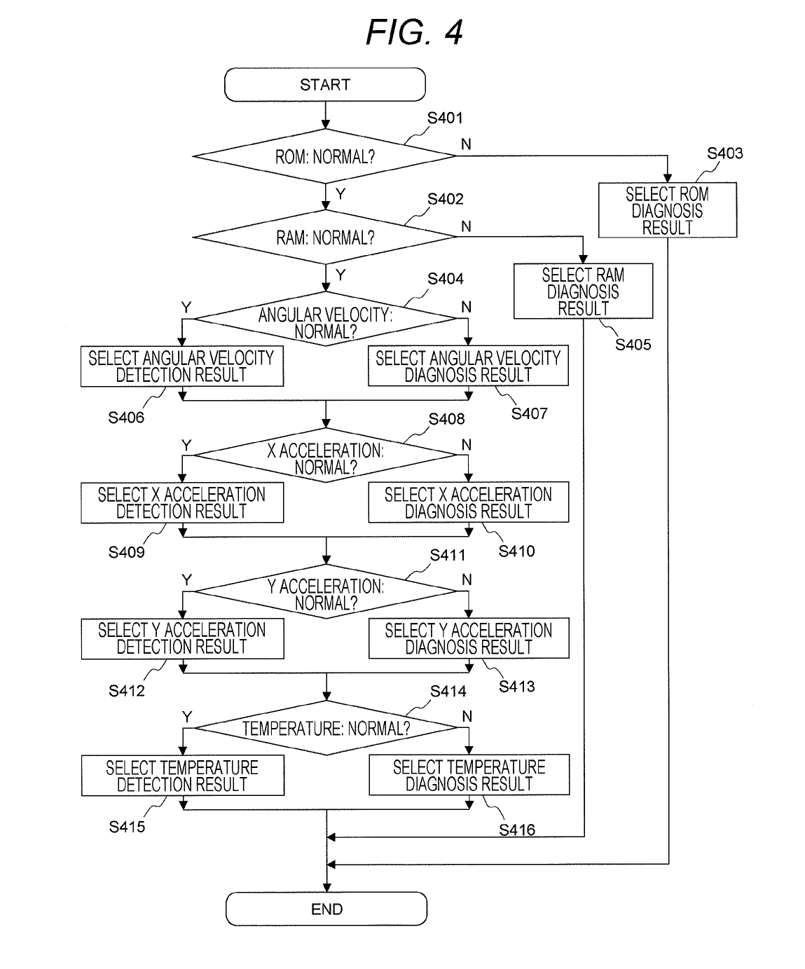

FIG. 4 is a diagram showing an operational flow of the selection unit 1712. In the following, each step in FIG. 4 will be described.

(FIG. 4: Step S401)

The selection unit 1712 determines, based on the bit b4 of the diagnosis information held in the data buffer 1711, whether the ROM 202 is normally operating or not. In the case of a normal operation, step S402 is performed, and in the case of an abnormal operation, step S403 is performed.

(FIG. 4: Step S402)

The selection unit 1712 determines, based on the bit b3 of the diagnosis information held in the data buffer 1711, whether the RAM 203 is normally operating or not. In the case of a normal operation, step S404 is performed, and in the case of an abnormal operation, step S405 is performed.

(FIG. 4: Step S403)

The selection unit 1712 notifies the selector 1713 of the selection of the diagnosis result of the ROM 202 (the bit b4).

(FIG. 4: Step S404)

The selection unit 1712 determines, based on the bits b5 to b7 of the diagnosis information held in the data buffer 1711, whether the angular velocity detection function of the angular velocity sensor 101 is normally operating or not. In the case of a normal operation, step S406 is performed, and in the case of an abnormal operation, step S407 is performed.

(FIG. 4: Step S405)

The selection unit 1712 notifies the selector 1713 of the selection of the diagnosis result of the RAM 203 (the bit b3).

(FIG. 4: Step S406)

The selection unit 1712 notifies the selector 1713 of the selection of the detection result of the angular velocity sensor 101.

(FIG. 4: Step S407)

The selection unit 1712 notifies the selector 1713 of the selection of the diagnosis result of the angular velocity sensor 101 (the bits b5 to b7).

(FIG. 4: Step S408)

The selection unit 1712 determines, based on the bit b2 of the diagnosis information held in the data buffer 1711, whether the X-axis direction acceleration detection function of the accelerometer is normally operating or not. In the case of a normal operation, step S409 is performed, and in the case of an abnormal operation, step S410 is performed.

(FIG. 4: Step S409)

The selection unit 1712 notifies the selector 1713 of the selection of the detection result of the accelerometer regarding the X-axis direction acceleration.

(FIG. 4: Step S410)

The selection unit 1712 notifies the selector 1713 of the selection of the diagnosis result of the X-axis direction acceleration detection function (the bit b2) of the accelerometer.

(FIG. 4: Step S411)

The selection unit 1712 determines, based on the bit b1 of the diagnosis information held in the data buffer 1711, whether the Y-axis direction acceleration detection function of the accelerometer is normally operating or not. In the case of a normal operation, step S412 is performed, and in the case of an abnormal operation, step S413 is performed.

(FIG. 4: Step S412)

The selection unit 1712 notifies the selector 1713 of the selection of the detection result of the accelerometer regarding the Y-axis direction acceleration.

(FIG. 4: Step S413)

The selection unit 1712 notifies the selector 1713 of the selection of the diagnosis result of the Y-axis direction acceleration detection function (the bit b1) of the accelerometer.

(FIG. 4: Step S414)

The selection unit 1712 determines, based on the bit b0 of the diagnosis information held in the data buffer 1711, whether the temperature detection function of the temperature sensor 137 is normally operating or not. In the case of a normal operation, step S415 is performed, and in the case of an abnormal operation, step S416 is performed.

(FIG. 4: Step S415)

The selection unit 1712 notifies the selector 1713 of the selection of the detection result of the temperature sensor 137.

(FIG. 4: Step S416)

The selection unit 1712 notifies the selector 1713 of the selection of the diagnosis result of the temperature detection function of the temperature sensor 137 (the bit b0).

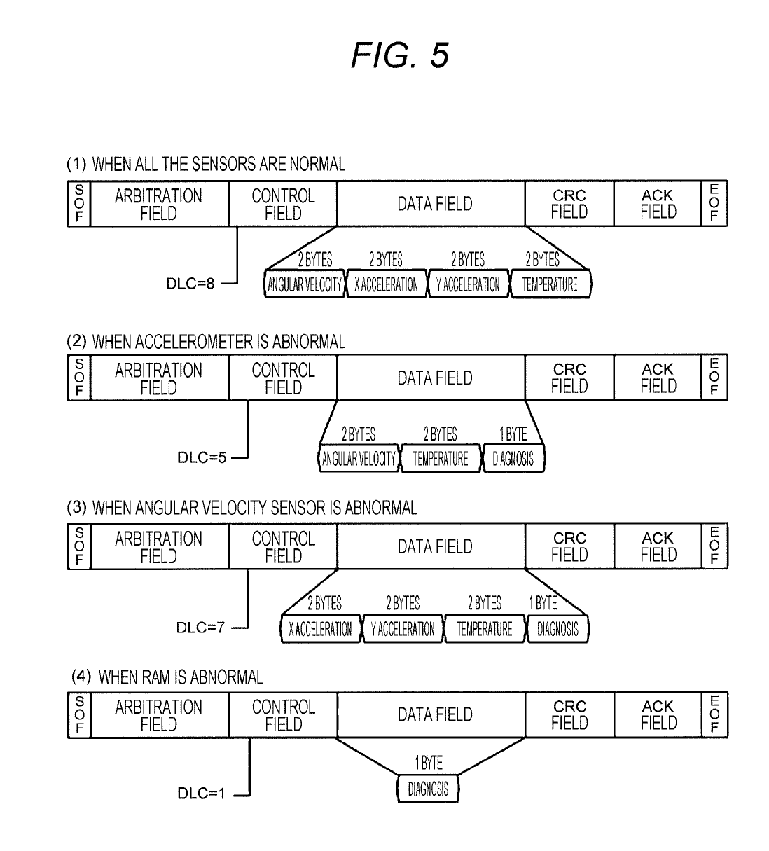

FIG. 5 is a diagram showing an example configuration of a communication frame that is to be output by the communication frame forming unit 1714 as a result of the operational flow in FIG. 4. An example is shown here where the communication frame is configured in the form of a CAN (Controller Area Network) frame.

A CAN communication frame includes, within one frame, an SOF (start of field), a control field, a data field, a CRC field, an ACK field, and an EOF (end of field). The control field holds a value (DLC: Data Length Code) indicating the length of the data field. The detection result and the diagnosis result of each sensor may be stored in the data field.

(1) When All the Sensors Are Normal

In the case all the sensors are normally operating, the selection unit 1712 selects the detection result of each sensor, and does not select the diagnosis result. As a result, the communication frame forming unit 1714 stores, in the communication frame, the detection result of each sensor, but not the diagnosis result. In this case, the length of the data field is 2 bytes×4=8 bytes.

(2) When the Accelerometer is Abnormal

In the case the accelerometer is abnormal, the selection unit 1712 does not select the detection result of the accelerometer. Instead, the diagnosis result of each sensor is selected. As a result, the communication frame forming unit 1714 stores, in the communication frame, the detection result of the angular velocity sensor, the detection result of the temperature sensor, and the diagnosis result of each sensor. In this case, the length of the data field is 2 bytes×2+1 byte=5 bytes.

(3) When the Angular Velocity Sensor is Abnormal

In the case the angular velocity sensor 101 is abnormal, the selection unit 1712 does not select the detection result of the angular velocity sensor 101. Instead, the diagnosis result of each sensor is selected. As a result, the communication frame forming unit 1714 stores, in the communication frame, the detection result of the accelerometer, the detection result of the temperature sensor 137, and the diagnosis result of each sensor. In this case, the length of the data field is 2 bytes×3+1 byte=7 bytes.

(4) When the RAM is Abnormal

In the case the RAM 203 is abnormal, the selection unit 1712 does not select the detection result of each sensor. Instead, the diagnosis result of each sensor is selected. As a result, the communication frame forming unit 1714 stores, in the communication frame, the diagnosis result of each sensor. In this case, the length of the data field is 1 byte. The same can be said for a case where the ROM 202 is abnormal.

The length of the data field is uniquely determined in the case all the sensors are normal and in the case the ROM 202 or the RAM 203 is abnormal. Thus, in these cases, an external device receiving the communication frame shown in FIG. 5 may determine which value is stored in the data field simply by checking the value of the DLC.

### First Embodiment: Summary

As described above, the physical quantity detection device 1000 of the first embodiment transmits the detection result of a sensor in the case the sensor is normally operating, and transmits the diagnosis result without transmitting the detection sensor of a sensor in the case the sensor is not normally operating. Accordingly, only the information that needs to be notified to an external device is transmitted, and the communication load may be reduced. Further, an external device receives only the information that the external device needs to be notified of, and the processing load at the time of reception may be reduced.

Furthermore, according to the physical quantity detection device 1000 of the first embodiment, the DLC is 8 when only the detection result of each sensor is transmitted, and the DLC is 1 when only the diagnosis result is to be transmitted without transmitting the detection result of each sensor. Accordingly, an external device which has received a communication frame may grasp which data is stored in the communication frame without reading the contents of the data field, and the processing load may be reduced.

### Second Embodiment

In the first embodiment, the selection unit 1712 selects only the information that needs to be notified to an external device, using the processing flow described with reference to FIG. 4. This is significant in reducing the communication load of the network and the processing load of the receiving side, and is also significant in restricting the amount of information in the data field to a predetermined limit.

For example, in the case of adopting a CAN frame as the format of the communication frame, there is a restriction that the data field of the CAN frame is maximum 8 bytes. Thus, to transmit data exceeding 8 bytes, data has to be transmitted over a plurality of communication frames, and the processing load is increased at both the data transmitting side and the data receiving side.

According to the method described in the first embodiment, the maximum size of the data field is 8 bytes shown in (1) of FIG. 5, and thus, the detection results or the diagnosis results of all the sensors may be transmitted by only one communication frame.

A similar method may be used also in the case of adopting a frame format other than the CAN frame. That is, the selection unit 1712 may select information to be transmitted in such a way that the information is within the maximum amount of information that can be contained in one frame or one packet allowed by the communication frame format, the communication packet format or the like adopted by the communication unit 171.

If the amount of information does not fit in one frame or one packet even if the selection unit 1712 has selected the minimum amount of information to be transmitted, the lower bit of the sensor detection result may be compressed according to the required accuracy for the sensor detection result.

For example, the detection result of each sensor is expressed in 16 bits in FIG. 3 of the first embodiment, but in the case only 8 bits of expression is required with respect to the accuracy of the sensor detection result, the lower 8 bits may be compressed by omitting, advancing or rounding off the lower 8 bits. The amount of information equivalent to 32 bits may thereby be reduced, and even when a frame format according to which the maximum amount of information that may be stored in the data field is 4 bytes is adopted, for example, all the detection results or the diagnosis results may be transmitted in one transmission. Further, even if there are five to eight sensors, the detection results of all the sensors may be transmitted in one transmission by compressing the amount of information in the above manner.

### Third Embodiment

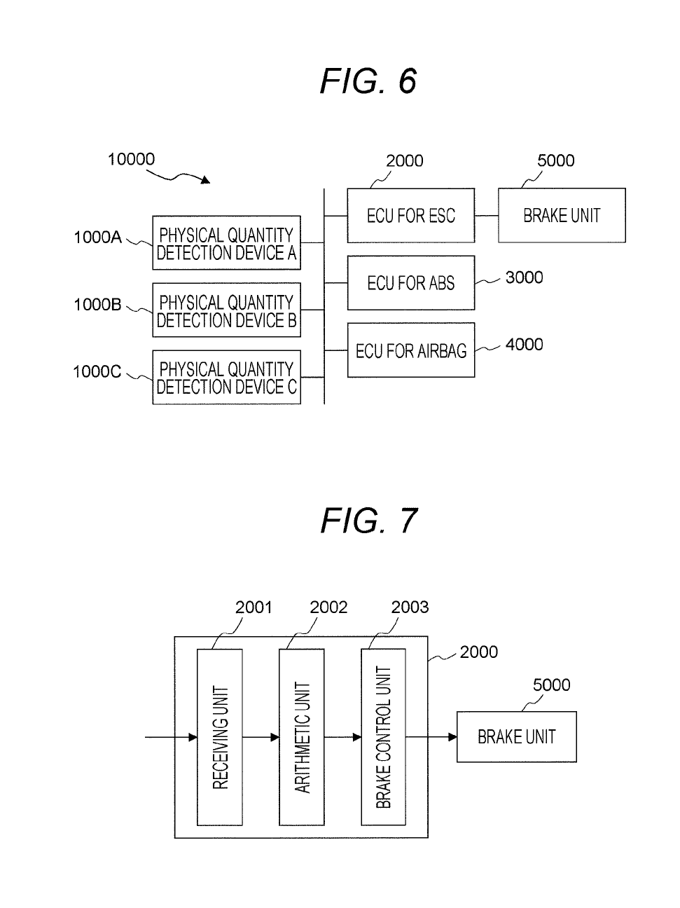

FIG. 6 is a configuration diagram of a network system 10000 according to a third embodiment of the present invention. The network system 10000 is an in-vehicle network installed inside a vehicle, and includes physical quantity detection devices 1000A, 1000B and 1000C, an ECU (Engine Control Unit) 2000 for ESC (Electronic Stability Control), an ECU 3000 for ABS (Anti-Lock Braking System), an ECU 4000 for an airbag, and a brake unit 5000.

The physical quantity detection device 1000A is a detection device for detecting angular velocity and acceleration. The physical quantity detection device 1000B is a detection device for detecting the speed of a vehicle during travelling. The physical quantity detection device 1000C is a detection device for detecting the handle angle of the vehicle during travelling. These detection devices are configured in the same manner as the physical quantity detection device 1000 described in the first and second embodiments, but the quantity amount to be detected and the sensors for detecting the physical quantities are different. The configuration for selecting information to be transmitted to an external device is the same as those in the first and second embodiments. In the following, when referring collectively to the physical quantity detection devices 1000A to 1000C, they will be referred to as the physical quantity detection device(s) 1000.

The ECU 2000 for ESC is an ECU for performing control so as to prevent skidding of the vehicle. The ECU 3000 for ABS is an ECU for performing control so as to prevent slipping at the time of sudden braking of the vehicle during travelling. The ECU 4000 for an airbag is an ECU for controlling activation of an airbag at the time of vehicle collision. The brake unit 5000 separately controls each of four brakes, at the front, rear, right and left, using hydraulic pressure, according to an instruction from the ECU 2000 for ESC.

The detection devices 1000A to 1000C shown in FIG. 6 transmit detection results of sensors to respective ECUs via the in-vehicle network. Each ECU performs the control function thereof using the detection result of the sensor.

Each ECU corresponds to a “receiving device” of the third embodiment. In the third embodiment, the in-vehicle network and an in-vehicle control unit (ECU) are indicated as the examples of the structural elements of the network system 10000, but other network configurations may also be adopted.

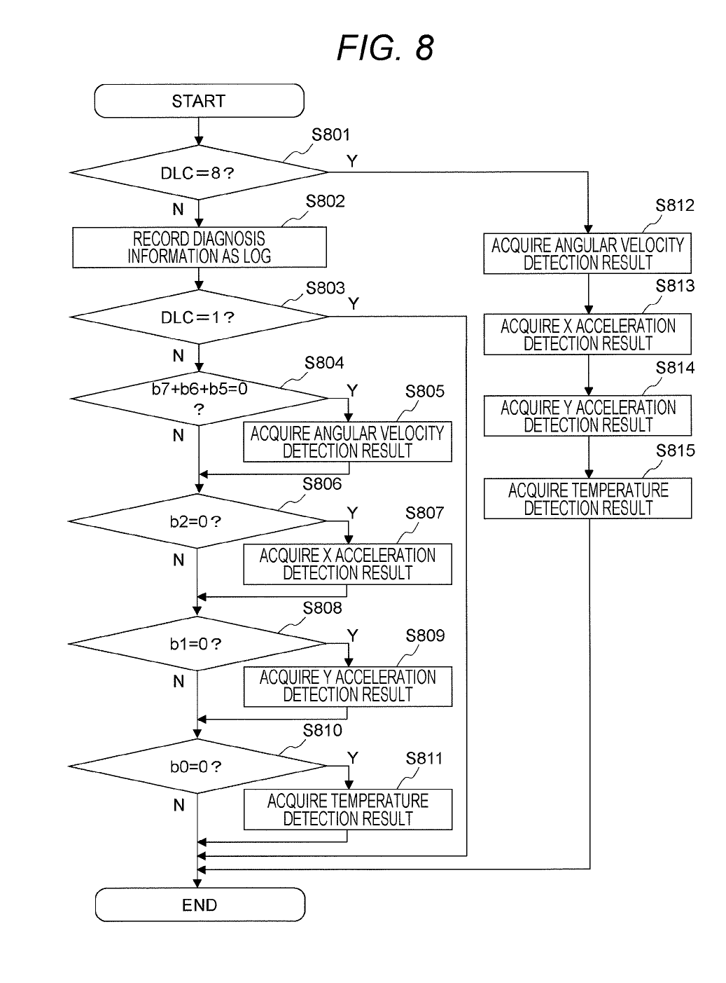

FIG. 7 is a functional block diagram of the ECU 2000 for ESC. The ECU 2000 for ESC includes a receiving unit 2001, an arithmetic unit 2002, and a brake control unit 2003. The receiving unit 2001 receives from the physical quantity detection devices 1000A to 1000C the detection results of respective sensors. The arithmetic unit 2002 performs the processing flow described below with reference to FIG. 8, and extracts the detection result of each sensor. The brake control unit 2003 outputs an operation instruction to the brake unit 5000 based on the detection result of each sensor extracted by the arithmetic unit 2002.

Here, only the configuration of the ECU 2000 for ESC is described, but the ECU 3000 for ABS and the ECU 4000 for an airbag may be configured in the same manner.

FIG. 8 is an operational flow at the time of the ECU 2000 for ESC receiving a communication frame from the physical quantity detection device 1000. The same process may be performed for the ECUs other than the ECU 2000 for ESC. In the following, each step in FIG. 8 will be described.

(FIG. 8: Step S801)

The arithmetic unit 2002 acquires the value of the DLC of a communication frame received from the physical quantity detection device 1000. If the DLC is 8, step S812 is performed; otherwise, step S802 is performed.

(FIG. 8: Step S802)

In the case the DLC is not 8, the arithmetic unit 2002 determines that there is an abnormality in a certain sensor, and records the diagnosis information as a log. The recording destination of the log may be a storage device such as a memory or a hard disk device provided in the ECU 2000 for ESC, for example.

(FIG. 8: Step S803)

In the case the DLC is 1, the arithmetic unit 2002 determines that the detection result of each sensor is not stored in the communication frame received from the physical quantity detection device 1000 and ends the operational flow, but in other cases, step S804 is performed.

(FIG. 8: Step S804)

The arithmetic unit 2002 obtains the sum of the bits b5 to b7 of the diagnosis information held in the data field of the communication frame. If the sum is zero, all the bits are zero and the angular velocity sensor 101 is determined to be normally operating, and step S805 is performed. In other cases, the process skips to step S806.

(FIG. 8: Step S805)

The arithmetic unit 2002 acquires the detection result of the angular velocity sensor 101 from the data field of the communication frame. The acquired detection result is recorded in the storage device such as a memory or a hard disk device provided in the ECU 2000 for ESC, for example. The same can be said for the case of acquiring the detection result of each sensor in the following steps.

(FIG. 8: Step S806)

The arithmetic unit 2002 acquires the value of the bit b2 of the diagnosis information held in the data field of the communication frame. If b2 is zero, the X-axis direction acceleration detection function of the accelerometer is determined to be normally operating, and step S807 is performed. In other cases, the process skips to step S808.

(FIG. 8: Step S807)

The arithmetic unit 2002 acquires the X-axis direction acceleration detection result of the accelerometer from the data field of the communication frame.

(FIG. 8: Step S808)

The arithmetic unit 2002 acquires the value of the bit b1 of the diagnosis information held in the data field of the communication frame. If b1 is zero, the Y-axis direction acceleration detection function of the accelerometer is determined to be normally operating, and step S809 is performed. In other cases, the process skips to step S810.

(FIG. 8: Step S809)

The arithmetic unit 2002 acquires the Y-axis direction acceleration detection result of the accelerometer from the data field of the communication frame.

(FIG. 8: Step S810)

The arithmetic unit 2002 acquires the value of the bit b0 of the diagnosis information held in the data field of the communication frame. If b0 is zero, the temperature sensor 137 is determined to be normally operating, and step S811 is performed. In other cases, the operational flow is ended.

(FIG. 8: Step S811)

The arithmetic unit 2002 acquires the detection result of the temperature sensor 137 from the data field of the communication frame.

(FIG. 8: Steps S812 to S815)

The arithmetic unit 2002 performs the same processing as steps S805, S807, S809 and S811.

### Third Embodiment: Summary

As described above, according to the network system 10000 of the third embodiment, only in the case the DLC is not 8, that is, only in the case the diagnosis result of each sensor is received, each ECU records the diagnosis result as a log. This allows the processing load regarding a log recording process to be reduced.

Further, according to the network system 10000 of the third embodiment, in the case the DLC is 8, each ECU determines that all the sensors are normally operating, and records all the detection results without performing steps S802 to S811. This eliminates the necessity to determine which detection result is included based on each of the bits of the diagnosis information included in the data field, and the processing load of each ECU may be reduced.

Furthermore, according to the network system 10000 of the third embodiment, in the case the DLC is 1, each ECU determines that the detection results of the sensors are not included in the data field, and does not perform the process for receiving these detection results. That the subsequent receiving process is not to be performed may thereby be decided at an early state of the receiving process, and the processing load of each ECU may be reduced.

Moreover, according to the network system 10000 of the third embodiment, each ECU determines which sensor's detection result is included in the data field, based on the values of the bits b0 to b7 included in the diagnosis information, and omits the process for acquiring a detection result that is not included. This allows the detection result of each sensor to be acquired by the minimum process, and the processing load of each ECU may be reduced.

### Fourth Embodiment

The first to third embodiments are premised on that the type of sensor provided in the physical quantity detection device 1000 is determined in advance, but also in the case described in the third embodiment of using a plurality of physical quantity detection devices 1000 that are different only with respect to the types of sensors, the process to be performed by the communication unit 171 is the same.

Accordingly, in the fourth embodiment of the present invention, a configuration for making the process of the communication unit 171 common for the physical quantity detection devices 1000 will be described. Other configurations are the same as the first to third embodiments, and thus, in the following, the configuration for making the process of the communication unit 171 common will be mainly described.

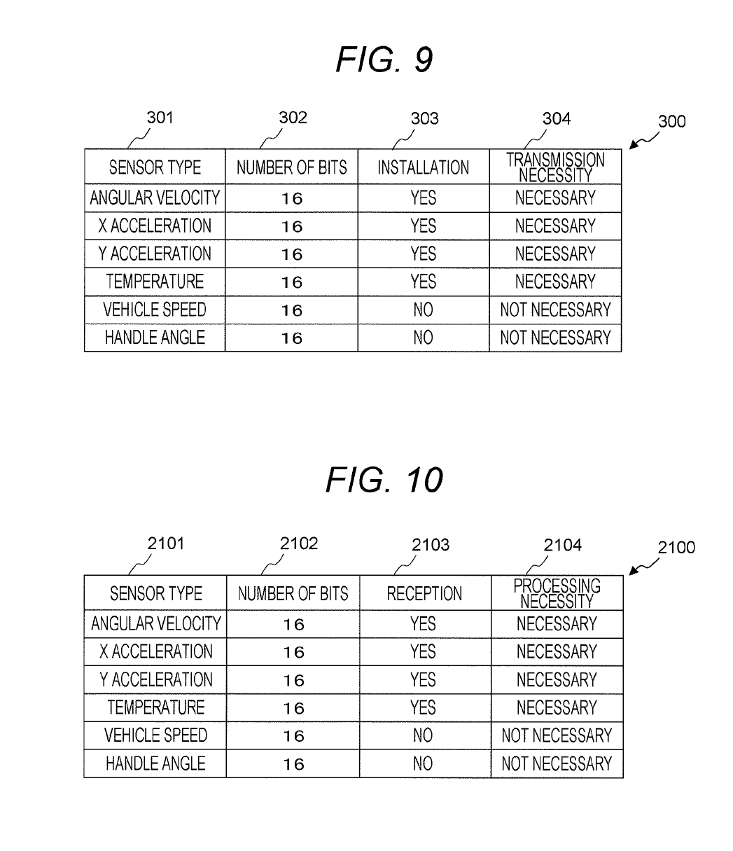

FIG. 9 is a diagram showing a structure of a definition table 300 held in the ROM 202 of the physical quantity detection device 1000 and example data. The definition table 300 is a table defining which sensor's detection result the physical quantity detection device 1000 should acquire and transmit to an external device, and includes a sensor type field 301, a number-of-bits field 302, an installation field 303, and a transmission necessity field 304.

The sensor type field 301 is a field listing the types of sensors that are possibly installed in the physical quantity detection device 1000. The number-of-bits field 302 holds a value indicating the number of bits necessary to express the detection result of a sensor identified by the value of the sensor type field 301. The installation field 303 holds a value indicating whether or not a sensor identified by the value of the sensor type field 301 is installed in the physical quantity detection device 1000. The transmission necessity field 304 holds a value indicating whether or not the detection result of a sensor identified by the value of the sensor type field 301 has to be transmitted to an external device.

The example data shown in FIG. 9 shows the example data of the definition table 300 corresponding to the physical quantity detection devices 1000 described in the first and second embodiments, and the physical quantity detection device 1000A described in the third embodiment. In this case, it can be seen that the physical quantity detection devices 1000 and 1000A are to acquire, and transmit, the detection result of the angular velocity sensor, the detection result of the accelerometer, and the detection result of the temperature sensor. The selection unit 1712 reads the definition table 300 to grasp which sensor's detection result the data stored in the data buffer 1711 is, and then, selects only the detection result to be transmitted and notifies the selector 1713 of the same.

The processes to be performed by the communication unit 171 may be defined by changing the contents of the definition table 300, and thus, the communication unit 171 does not have to be developed for each type of sensor provided in each physical quantity detection device 1000, and only the definition data 300 has to be adjusted. This enables to reduce the burden regarding development of the physical quantity detection device 1000. For example, if the record regarding a vehicle speed sensor in the definition table 300 is validated, the process to be performed by the communication unit 171 of the physical quantity detection device 1000B described in the third embodiment may be defined.

FIG. 10 is a diagram showing a structure of a definition table 2100 held in each ECU and example data. An example of a definition table 2100 held in the ECU 2000 for ESC is shown here, but the same definition table may be held in other ECUs.

The definition table 2100 is a table defining which sensor's detection result the ECU 2000 for ESC is to process, and this table serves, at the ECU 2000 for ESC, the same role as the definition table 300. The definition table 2100 includes a sensor type field 2101, a number-of-bits field 2102, a reception field 2103, and a processing necessity field 2104.

The sensor type field 2101 is a field listing the types of sensors with respect to which reception is possibly performed by the ECU 2000 for ESC. The number-of-bits field 2102 holds a value indicating the number of bits expressing the detection result of a sensor identified by the value of the sensor type field 2101. The reception field 2103 holds a value indicating whether or not the ECU 2000 for ESC is to receive the detection result of a sensor identified by the value of the sensor type field 2101, that is, whether or not the detection result will be transmitted from the physical quantity detection device 1000 to the ECU 2000 for ESC. The processing necessity field 2104 holds a value indicating whether or not the ECU 2000 for ESC has to process the detection result of a sensor identified by the value of the sensor type field 2101.

The processes to be performed by the arithmetic unit 2002 of the ECU 2000 for ESC may be defined by changing the contents of the definition table 2100, and thus, the arithmetic unit 2002 does not have to be developed for each type of sensor whose detection result is to be processed by each ECU, and only the definition data 2100 has to be adjusted. This enables to reduce the burden regarding development of the ECU.

Heretofore, the invention made by the present inventor has been concretely described based on the embodiments, but the present invention is not limited to the embodiments described above, and it is needless to say that various modifications may be made without departing from the scope of the invention.

Further, the configurations, functions, processing units and the like described above may be realized as hardware by being wholly or partially designed as an integrated circuit, for example, or as software by a processor executing a program for realizing each of the functions. Information such as a table and the program for realizing each function may be stored in a storage device such as a memory or a hard disk, an IC card, or a storage medium such as a DVD.

### REFERENCE SIGNS LIST

101 angular velocity sensor
102 oscillator
103 fixed electrode
104, 105 electrode
106, 107 fixed electrode
108, 109 fixed electrode
110 capacitance detector
112 capacitance detector
122 VCO
123 clock generation unit
128, 129 oscillator
131 to 133 electrode
135, 136 capacitance detector
137 temperature sensor
138 AD converter
139 angular velocity characteristic correction unit
140 X-axis direction acceleration characteristic correction unit
141 Y-axis direction acceleration characteristic correction unit
145, 146 AD converter
148, 149 AD converter
151 driving frequency adjustment unit
152 driving amplitude adjustment unit
153 angular velocity detection unit
161 to 166 diagnosis unit
167 diagnosis voltage control unit
171 communication unit
1711 data buffer
1712 selection unit
1713 selector
1714 communication frame forming unit
200 microcomputer
201 CPU
202 ROM
203 RAM
300 definition table
301 sensor type field
302 number-of-bits field
303 installation field
304 transmission necessity field
1000 physical quantity detection device
2000 ECU for ESC
2001 receiving unit
2002 arithmetic unit
2003 brake control unit
2100 definition table
2101 sensor type field
2102 number-of-bits field
2103 reception field
2104 processing necessity field
3000 ECU for ABS
4000 ECU for airbag
5000 brake unit
10000 network system

1. A physical quantity detection device comprising:
a sensor for detecting a physical quantity;
a diagnosis unit for diagnosing an operating state of the sensor;
a communication unit for transmitting a detection result of the sensor and a diagnosis result of the diagnosis unit; and
a selection unit for selecting either the detection result of the sensor or the diagnosis result of the diagnosis unit the communication unit is to transmit,
wherein the selection unit
selects the detection result of the sensor in a case the diagnosis unit diagnosed that the sensor is normally operating, and
selects the diagnosis result of the diagnosis unit without selecting the detection result of the sensor in a case the diagnosis unit diagnosed that the sensor is not operating normally.

2. The physical quantity detection device according to claim 1, wherein in a case the detection result of the sensor or the diagnosis result of the diagnosis unit cannot be contained in one communication packet, the communication unit compresses information describing the detection result of the sensor sequentially from a lower bit and reduces an amount of information.

3. The physical quantity detection device according to claim 1,
wherein, when transmitting only the detection result of the sensor, the communication unit transmits together information to the effect, and
wherein, when the detection result of the sensor is not to be transmitted, the communication unit transmits together information to the effect.

4. The physical quantity detection device according to claim 1, comprising:
a definition table defining a type of the sensor included in the physical quantity detection device,
wherein the communication unit transmits the detection result of the sensor defined by the definition table and the diagnosis result of the diagnosis unit regarding the sensor.

5. The physical quantity detection device according to claim 1,
wherein the sensor
includes an oscillation body capable of being displaced in mutually orthogonal first direction and second direction, and
detects an amount of displacement at a time when the oscillation body is displaced in the second direction by occurrence of an angular velocity as an angular velocity, in a state where the oscillation body is oscillated in the first direction.

6. The physical quantity detection device according to claim 1,
wherein the sensor
includes an oscillation body capable of being displaced in mutually orthogonal first direction and second direction, and
detects an amount of displacement at a time when the oscillation body is displaced in the first direction and the second direction as acceleration.

7. A network system comprising:
a physical quantity detection device according to claim 1; and
a receiving device for receiving information transmitted by the physical quantity detection device.

8. A network system comprising:
a physical quantity detection device according to claim 3; and
a receiving device for receiving information transmitted by the physical quantity detection device,
wherein the receiving device records a diagnosis result as a log only in a case the diagnosis result of the diagnosis unit is received from the physical quantity detection device.

9. The network system according to claim 8, wherein, upon receiving information indicating that only a detection result of the sensor is transmitted from the physical quantity detection device, the receiving device determines that the sensor is normally operating, records all detection results of the sensor, and does not perform a process for receiving the diagnosis result of the diagnosis unit.

10. The network system according to claim 8, wherein, upon receiving information indicating that a detection result of the sensor is not transmitted from the physical quantity detection device, the receiving device does not perform a process for receiving the detection result of the sensor.

11. The network system according to claim 8, wherein in a case a diagnosis result of the diagnosis unit received from the physical quantity detection device indicates that the sensor is not normally operating, the receiving device treats the information received from the physical quantity detection device as the information not including a detection result of the sensor.

12. A network system comprising:
a physical quantity detection device according to claim 1; and
a receiving device for receiving information transmitted by the physical quantity detection device,
wherein the receiving device
includes a definition table defining the type of a detection result of the sensor received from the physical quantity detection device, and
processes information received from the physical quantity detection device as the detection result of the sensor defined by the definition table and a diagnosis result of the diagnosis unit regarding the sensor.
